(19) United States
(12) Patent Application Publication
(10) Pub. No.: US 2026/0316527 A1
(43) Pub. Date: Oct. 15, 2026

(54) AIR VENT, AIR SYSTEM AND VEHICLE SERIES

(71) Applicant: FAURECIA AUTOMOTIVE INTERIOR SYSTEM (SHANGHAI) CO., LTD., Shanghai (CN)

(72) Inventors: WEIFENG SUN, Shanghai (CN); JINBIAO XUE, Shanghai (CN)

(21) Appl. No.: 19/647,864

(22) Filed: Apr. 14, 2026

(30) Foreign Application Priority Data
Apr. 14, 2025 (CN) 202520706350.3

(51) Int. Cl. B60H 1/34

(52) U.S. Cl. CPC B60H 1/3421

(57) ABSTRACT

The present disclosure relates to an air vent, an air system and a vehicle series. The air vent includes: a first module including a first mounting frame capable of mounting an air guiding assembly; a second module including an upstream housing and/or a downstream housing, the upstream housing being located upstream to the first module and provided with a first inlet and a first outlet, and the downstream housing being located downstream to the first module and provided with a second inlet and a second outlet. An air vent flow path provided by the first module and the second module includes: an airflow enters through the first inlet, passes through the first outlet, the air vent guiding assembly of the first module and the second inlet in sequence, and finally the airflow is output to the outside at the second outlet.

### CROSS-REFERENCE TO RELATED APPLICATION

This application claims priority of Chinese Patent Application No. 202520706350.3, filed on Apr. 14, 2025, the contents of which are entirely incorporated herein by reference.

### Field

The present disclosure relates to an air vent, an air system and a vehicle series.

### Background

In vehicles, for example automobiles, air vents are generally provided. For instance, air vents may be arranged on an instrument panel to provide functions such as automotive air conditioning.

An inlet of an air vent is generally connected to an air duct, and the air duct is connected at the other side to a heating, ventilation and air conditioning system (HVAC), while an outlet of the air vent is generally arranged on a panel, for example an instrument panel.

The inventors have found that since the arrangement and extension of air ducts inside a vehicle need to meet space layout requirements of the vehicle, connection structures between air ducts at different positions and inlets of different air vents have different orientations, and orientations corresponding to inlets of different air vents are also different; in addition, due to personalized demands and/or space layout reasons, structures of outlets of different air vents may also differ. Air vents are generally formed by injection molding, and changes in structures of the inlet and the outlet lead to the need of remolding and overall redesign and development of the entire air vent, resulting in high production costs of the air vent as well as the air system and the vehicle including the same, and inconvenience in space layout of the air vent.

Therefore, there is a need in the art for an air vent, an air system and a vehicle series to solve at least one of the above problems.

### Summary

The present disclosure provides an air vent.

The present disclosure provides an air system.

The present disclosure provides a vehicle series.

The present disclosure provides an air vent according to some embodiments of the disclosure. The air vent includes: a first module including a first mounting frame capable of mounting an air guiding assembly; a second module including an upstream housing and/or a downstream housing, the upstream housing being located upstream to the first module and provided with a first inlet and a first outlet, and the downstream housing being located downstream to the first module and provided with a second inlet and a second outlet. An air vent flow path provided by the first module and the second module includes: an airflow enters through the first inlet, passes through the first outlet, the air vent guiding assembly of the first module and the second inlet in sequence, and finally the airflow is output to the outside at the second outlet; and the first module and the second module are separate parts, the first module is a carry-over module of the air vent, and the second module is an updated module of the air vent.

In some embodiments of the air vent, an inner wall of the first mounting frame defines a guiding area, the air vent guiding assembly is mounted in the guiding area, the air vent guiding assembly includes horizontal guiding blades and/or vertical guiding blades, and the first mounting frame is further mounted with a motor; the motor is capable of driving the horizontal guiding blades and/or the vertical guiding blades to move to adjust outputting direction of air flow of the second outlet.

In some embodiments of the air vent, an outer wall of the first mounting frame is provided with motor mounting seats on opposite sides in a vertical direction and on opposite sides in a horizontal direction.

In some embodiments of the air vent, the outer wall of the first mounting frame further provides a plug connector mounting seat, and the plug connector mounting seat is located at adjacent motor mounting seats, and adjacent motors installed corresponding to the adjacent motor mounting seats are able to share the same plug connector mounting seat.

In some embodiments of the air vent, the first mounting frame is square, the motor mounting seats are arranged in a middle area of each side of the square, and the plug connector mounting seat is arranged at an intersection area of adjacent sides of the square.

In some embodiments of the air vent, the first module is connected to the upstream housing and/or the downstream housing by a detachable connecting structure; the detachable connecting structure includes a snap-fit connecting structure.

In some embodiments of the air vent, the first module includes the first mounting frame, and the second module includes the upstream housing and the downstream housing; or the first module includes the first mounting frame and the upstream housing, and the second module includes the downstream housing; or the first module includes the first mounting frame and the downstream housing, and the second module includes the upstream housing.

In addition, the present disclosure provides an air system according to some embodiments of the disclosure. The air system includes: the air vent according to the above embodiments; an air duct; and a heating, ventilation and air conditioning system. An upstream end of the air duct is connected to the heating, ventilation and air conditioning system, and a downstream end of the air duct is connected to the first inlet of the air vent.

In some embodiments of the air system, the air system includes a plurality of air vents including a first air vent and a second air vent, the first module of the first air vent is identical in structure to that of the second air vent, and the second module of the first air vent is different in structure from that of the second air vent.

In addition, the present disclosure provides a vehicle series according to some embodiments of the disclosure. Each vehicle of the vehicle series includes the air vent according to the above embodiments, and the air vent of each vehicle of the vehicle series has an identical first module, and the second modules of at least two vehicles of the vehicle series are different.

In some embodiments of the vehicle series, the vehicle further includes a panel; and the second outlet provided by the downstream housing of the air vent is located on a surface of the panel; the panel is provided with a functional part adjacent to the second outlet; an outer wall of the first mounting frame is provided with motor mounting seats on opposite sides in a vertical direction and on opposite sides in a horizontal direction, and the motor mounting seat closest to the functional part is not provided with a motor.

### DESCRIPTION OF ATTACHED DRAWINGS

The above and other features, properties and advantages of the present disclosure will become more apparent from the following description of embodiments with reference to the accompanying drawings, in which:

FIG. 1 is a schematic structural diagram of a vehicle according to an embodiment.

FIG. 2 is a schematic block diagram of an air system according to an embodiment.

FIG. 3 is a schematic diagram of an air system with a plurality of air vents according to an embodiment.

FIG. 4 is an assembled structural diagram of an air vent according to an embodiment.

FIG. 5 is an exploded structural diagram of an air vent according to an embodiment.

FIGS. 6-9 are structural diagrams of a first module of an air vent according to an embodiment.

FIG. 10 is a schematic diagram of motor mounting positions of a first module of an air vent according to a comparative example.

FIGS. 11-14 are schematic diagrams of motor mounting positions of a first module of an air vent according to some embodiments.

### REFERENCE NUMERALS

1000 - vehicle
1001 - instrument panel
100 - air system
200 - panel
201 - functional part
10 - air vent
101 - first air vent
102 - second air vent
20 - air duct
30 - heating, ventilation and air conditioning system
1 - first module
11 - first mounting frame
110 - guiding area
111 - motor mounting seat
112 - plug connector mounting seat
12 - air guiding assembly
121 - horizontal guiding blade
122 - vertical guiding blade
2 - second module
21 - upstream housing
211 - first inlet
212 - first outlet
213 - first fluid passage
22 - downstream housing
221 - second inlet
222 - second outlet
223 - second fluid passage
23 - snap-fit connecting structure
3 – motor

### DETAILED DESCRIPTION OF EMBODIMENTS

Hereinafter, embodiments of the present disclosure will be described in detail below. The following embodiments are only used to illustrate the embodiments of the present disclosure more clearly, and therefore are only used as examples, and cannot be used to limit the protection scope of the present disclosure.

Unless otherwise defined, all technical and scientific terms used herein have the same meaning as commonly understood by those skilled in the field of the present disclosure; the terms used herein are for the purpose of describing specific embodiments only and are not intended to limit the present disclosure; the terms "including" and "having" and any variations thereof in the description, claims and above brief description of the drawings of the present disclosure are intended to cover non-exclusive inclusion.

In the description of the embodiments of the present disclosure, the technical terms "first", "second" and the like are only used to distinguish different objects, and should not be construed as indicating or implying relative importance or implicitly indicating the number, specific order or primary-secondary relationship of the indicated technical features. In the description of the embodiments of the present disclosure, "a plurality of" means two or more, unless otherwise explicitly and in one embodiment defined.

Reference herein to "an embodiment" means that a particular feature, structure, or characteristic described in connection with the embodiment can be included in at least one embodiment of the present disclosure. The appearances of the phrase in various places in the specification are not necessarily all referring to the same embodiment, nor are separate or alternative embodiments mutually exclusive of other embodiments. It is explicitly and implicitly understood in the art that the embodiments described herein can be combined with other embodiments.

In the description of the embodiments of the present disclosure, the technical terms "center", "longitudinal", "lateral", "length", "width", "thickness", "upper", "lower", "front", "rear", "left", "right", "vertical", "horizontal", "top", "bottom", "inner", "outer", "clockwise", "counterclockwise", "axial", "radial", "circumferential" and the like indicate orientations or positional relationships based on those shown in the drawings, and are only for the convenience of describing the embodiments of the present disclosure and simplifying the description, but do not indicate or imply that the device or element referred to must have a specific orientation, be constructed and operated in a specific orientation, and therefore should not be construed as limiting the embodiments of the present disclosure.

In the description of the embodiments of the present disclosure, unless otherwise explicitly specified and limited, the technical terms "installed", "connected", "coupled", "fixed" and the like should be understood broadly, for example, they may be fixed connections, detachable connections, or integrated; they may be mechanical connections. For those of ordinary skill in the art, the specific meanings of the above terms in the embodiments of the present disclosure can be understood according to specific situations.

Although the air vent disclosed in the embodiments of the present disclosure is suitable for an instrument panel of an automobile, examples of the automobile include but are not limited to cars, trucks and buses. The number of wheels may vary among different types of automobiles, and one or more (for example all) wheels may be used for propulsion of the automobile. The automobile may include a passenger compartment accommodating one or more persons. However, the present disclosure is not limited thereto, and besides an automobile, vehicles such as a train, an airplane, a ship and the like, having a closed cabin requiring an air vent to provide an air conditioning function.

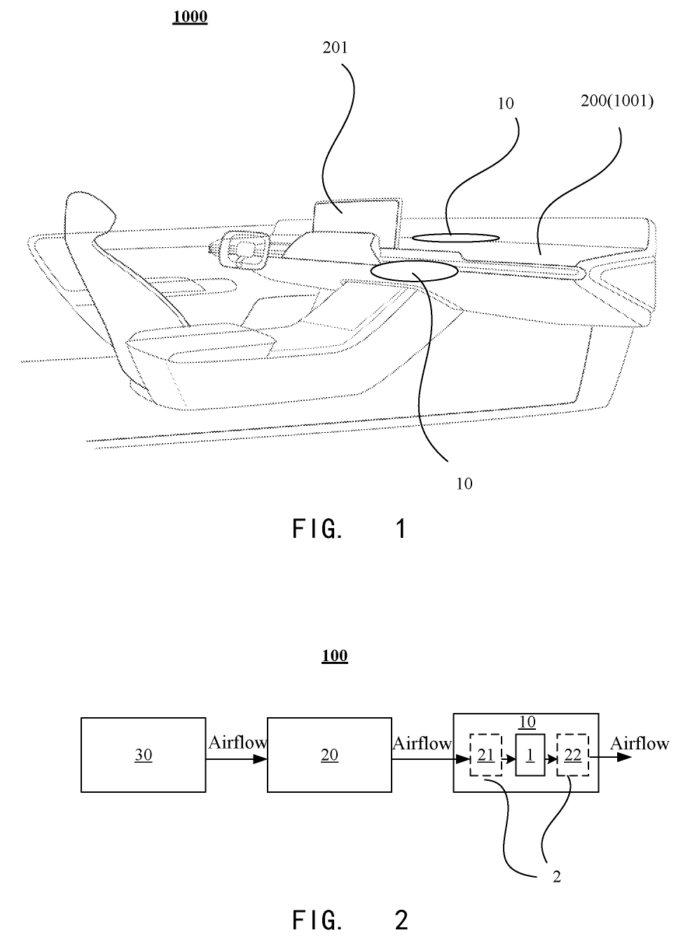

Referring to FIG. 1, taking an automobile as an example of a vehicle 1000 and a panel 200 as an example of an instrument panel 1001 of the automobile, the air vent 10 described in the following embodiments is disposed. In some embodiments, the second outlet 222 provided by the downstream housing 22 of the air vent 10 is located on a surface of the panel 200.

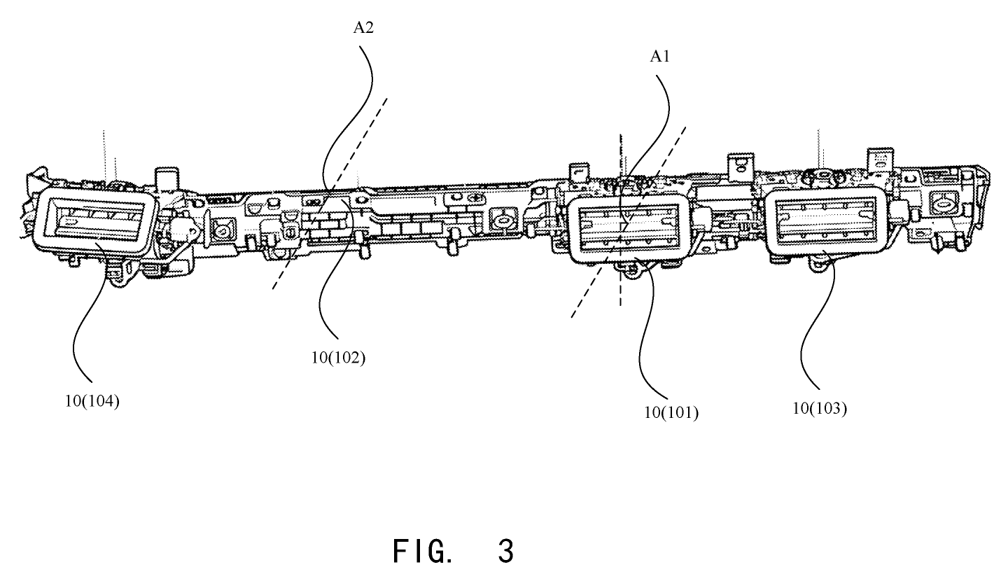

Referring to FIG. 2, the air system 100 of the vehicle includes the air vent 10, an air duct 20, and a heating, ventilation and air conditioning system 30. An upstream end of the air duct 20 is connected to the heating, ventilation and air conditioning (HVAC) system 30, and a downstream end of the air duct 20 is connected to the first inlet 211 of the air vent 10. The air duct 20 serves as an airflow passage in fluid communication with the heating, ventilation and air conditioning system 30 and the air vent 10 respectively. It can be understood that the air duct 20 and the heating, ventilation and air conditioning system 30 are generally invisible to occupants in the vehicle, so the air duct 20 and the heating, ventilation and air conditioning system 30 are not shown in FIG. 1.

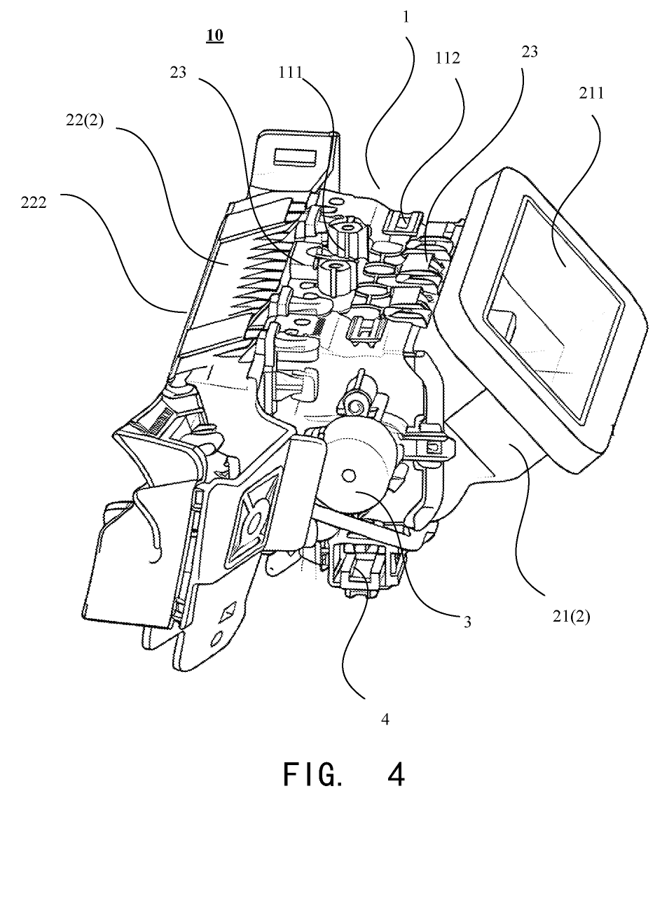

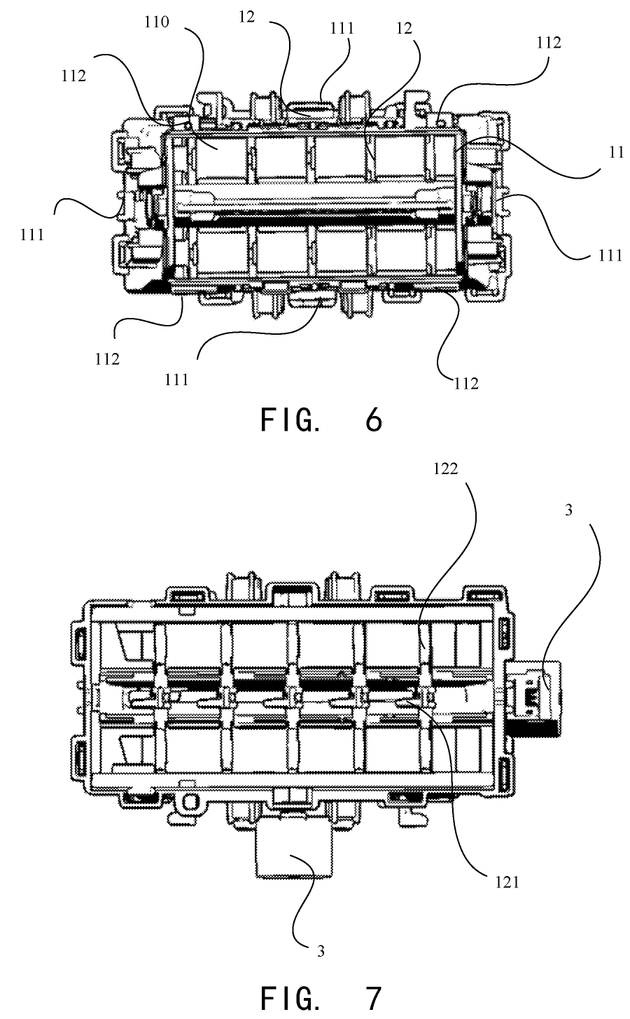

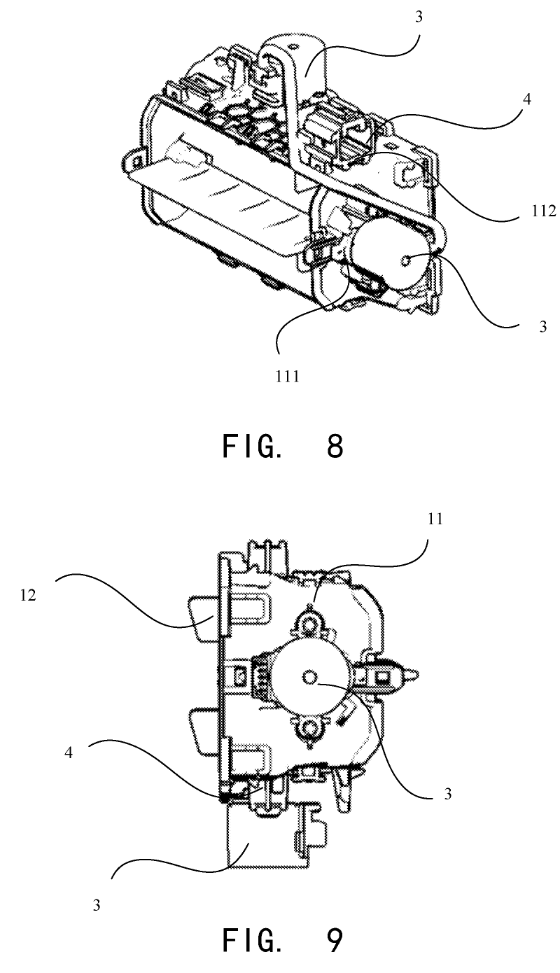

Referring to FIGS. 4-9, in some embodiments, the air vent 10 includes a first module 1 and a second module 2.

The first module 1 includes a first mounting frame 11 capable of mounting an air guiding assembly 12.

The second module 2 includes an upstream housing 21 and/or a downstream housing 22. The upstream housing 21 is located upstream to the first module 1 and has a first inlet 211, a first outlet 212, and a first fluid passage 213 extending between the first inlet 211 and the first outlet 212. The first inlet 211 is used for connecting with the air duct 20 of the air system 100 to provide fluid input of the air vent 10, that is, the first inlet 211 serves as an inlet of the entire air vent 10. The first outlet 212 is connected to the first module 1 to output fluid to the first module 1.

The downstream housing 22 is located downstream to the first module 1 and has a second inlet 221, a second outlet 222, and a second fluid passage 223 extending between the second inlet 221 and the second outlet 222. The second outlet 222 provides a surface of the air vent 10. The second inlet 221 is connected to the first module 1 to receive fluid output from the first module 1. The second outlet 222 is used for connecting with the panel 200 to allow flow to be output from the air vent 10, that is, the second outlet 222 serves as an outlet of the entire air vent 10.

An air vent flow path provided by the first module 1 and the second module 2 includes: an airflow enters through the first inlet 211, passes through the first outlet 212, the air vent guiding assembly 12 of the first module 1 and the second inlet 221 in sequence, and finally the airflow is output to the outside at the second outlet 222; and the first module 1 and the second module 2 are separate parts, the first module 1 is a carry-over module of the air vent 10, and the second module 2 is an updated module of the air vent 10. In the embodiments illustrated in the Figures, the second module 2 includes the upstream housing 21 and the downstream housing 22, but it can be understood that the second module 2 may also include one of the upstream housing 21 and the downstream housing 22, and the other serves as a component of the first module 1.

The term "carry-over module" herein means a part that can be directly carried over, i.e., directly used in subsequently developed different air vents 10 with the original structure, for development and manufacture of different air vents. The term "updated module" means a part that is updated and replaced for a subsequently developed and manufactured air vent relative to a previous air vent for development and manufacture of different air vents 10. In other words, the "carry-over module" is a common part for different air vents. For example, for two vehicles, a first vehicle and a second vehicle, the air vents may be different, such as a first air vent and a second air vent, but the first modules 1 as the "carry-over module" are the same, while the second modules 2 as the "updated module" are at least partially different between the first air vent and the second air vent. Of course, it is also possible to provide different first inlet 211 outlet angles for air ducts 20 extending in different installation positions within the same vehicle, that is, angles between a plane where the first inlet 211 is located and a vertical direction are different, i.e., different structures of the first inlet 211 are provided, different structures of the upstream housing 21 are provided, i.e., and the corresponding different second modules 2 are provided.

It can be understood that, in some embodiments, structure of the first module 1 and the second module 2 is that: the first module 1 includes the first mounting frame 11, and the second module 2 includes the upstream housing 21 and the downstream housing 22, that is, the first mounting frame 11 is a carry-over component of the carry-over module, and the upstream housing 21 and the downstream housing 22 are updated components of the updated module. In one embodiment, the first module 1 includes the first mounting frame 11 and the upstream housing 21, and the second module 2 includes the downstream housing 22, that is, the upstream housing 21 and the first mounting frame 11 are carry-over components of the carry-over module, and the downstream housing 22 is an updated component of the updated module. In some embodiments, the first module 1 includes the first mounting frame 11 and the downstream housing 22, and the second module 2 includes the upstream housing 21, that is, the downstream housing 22 and the first mounting frame 11 are carry-over components of the carry-over module, and the upstream housing 21 is an updated component of the updated module.

Beneficial effects of employing the above embodiments are: by splitting the air vent into a modular design and providing a carry-over module and an updated module, the carry-over module retains the first mounting frame 11 and the air vent guiding assembly 12 mounted thereon, while the second module including the upstream housing with the inlet of the air vent and/or the downstream housing with the outlet serves as the updated module. This saves a great deal of time spent on simulation, testing and other development work for employing the first mounting frame 11 and the air vent guiding assembly 12 in the entire air vent to meet basic functional requirements of air direction adjustment of the air vent. Meanwhile, the updated module can be redesigned and developed according to user demands. This shortens the development cycle of the air vent and reduces development costs. In addition, there is no need to remold the carry-over module, which saves mold costs, especially when the overall mold of the air vent is large. Further, the development cycle of the air system and the vehicle including the air vent is shortened, and manufacturing costs are reduced.

For example, for an air system 100 inside an automobile, as shown in FIG. 3, the air system 100 includes a plurality of air vents 10 including a first air vent 101 and a second air vent 102, but not limited to two, for example, as shown in FIG. 3, there are three air vents, i.e., a third air vent 103 is also provided.

The first module 1 of the first air vent 101 is identical in structure to that of the second air vent 102, and the upstream housing 21 and/or the downstream housing 22 of the first air vent 101 is different in structure from that of the second air vent 102.

In some embodiments, for example, as shown in FIG. 3 and described above, the first module 1 of the first air vent 101 and the second air vent 102 include the first mounting frame 11 and the downstream housing 22, and the second module 2 of the first air vent 101 and the second air vent 102 include the upstream housing 21, that is, the downstream housing 22 and the first mounting frame 11 of the first air vent 101 and the second air vent 102 are carry-over components of the carry-over module, and the upstream housing 21 is an updated component of the updated module.

In some embodiments, different structures of the upstream housing 21 are, as shown in FIG. 3, that an extension direction of the first fluid passage 213 of the first air vent 101 forms a different angle with the vertical direction from an extension direction of the first fluid passage 213 of the second air vent 102. As shown in FIG. 3, the extension direction of the first fluid passage 213 of the first air vent 101 forms a first angle A1 with the vertical direction, and the extension direction of the first fluid passage 213 of the second air vent 102 forms a second angle A2 with the vertical direction. The beneficial effect is to adapt to air ducts 20 extending in different directions and having different air output directions, thereby facilitating space layout of the air ducts 20 inside the vehicle. It can be understood that different structures of the upstream housing 21 are not limited to those described above. For example, an angle between a plane where the first inlet 211 of the first air vent 101 is located and the vertical direction may be different from an angle between a plane where the first inlet 211 of the second air vent 102 is located and the vertical direction. In addition, as described above, in the embodiment shown in FIG. 3, the upstream housing 21 has a different structure, and the downstream housing 22 is a component of the first module 1, and the downstream housing 22 of the first air vent 101 is the same as that of the second air vent 102, but the present disclosure is not limited thereto. In some embodiments, the upstream housing 21 and the downstream housing 22 of the first air vent 101 may be different from those of the second air vent 102, or the downstream housing 22 of the first air vent 101 may be different from that of the second air vent 102 while the upstream housing 21 of the first air vent 101 is the same as that of the second air vent 102. Different structures of the downstream housing 22 may also be similar to those of the upstream housing 22, for example, an extension direction of the fluid passage forms a different angle with the vertical direction, or a plane where the outlet is located forms a different angle with the vertical direction. For another example, for a vehicle series, the vehicle series may be, for example, all vehicle models produced on the same manufacturing platform, or all vehicle models of the same vehicle model with different configurations according to different prices. Each vehicle 1000 of the vehicle series includes the air vent 10 described in the embodiments having the same first module 1, and the second modules 2 of at least two vehicles 1000 of the vehicle series are different. For example, the same vehicle model has different second modules 2 according to different configurations, such as different upstream housings 21 and/or downstream housings 22.

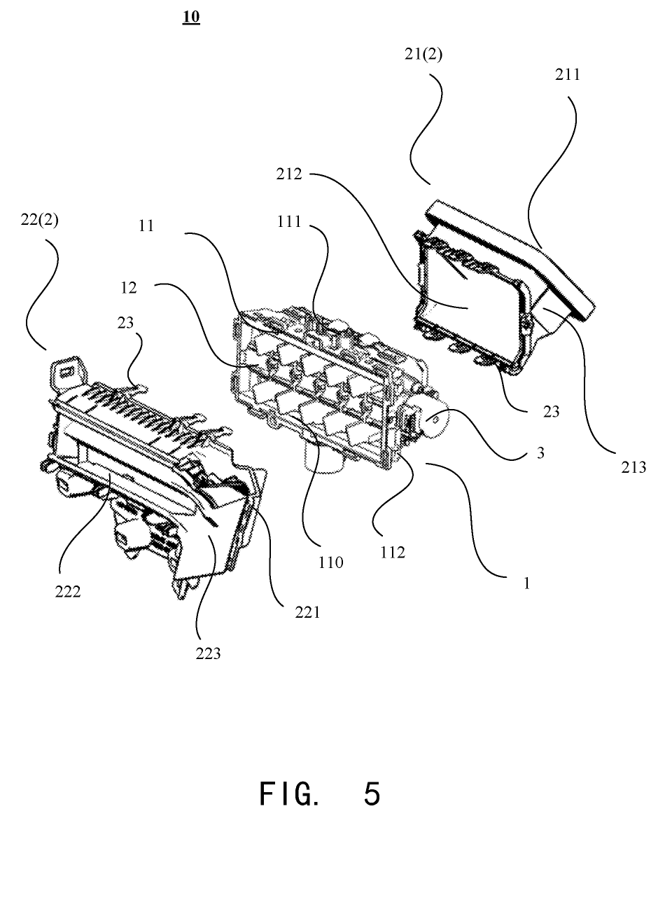

With continued reference to FIG. 5, in some embodiments, the first module 1 is connected to the upstream housing 21 and/or the downstream housing 22 by a detachable connecting structure; the detachable connecting structure includes a snap-fit connecting structure 23, which facilitates easy assembly. It can be understood that other detachable connecting structures may also be adopted, such as riveting, screw or bolt connection, etc., or non-detachable connecting structures may also be adopted, such as ultrasonic welding, etc., all of which are not limited thereto.

With continued reference to FIGS. 3-9, in some embodiments, the structure of the first mounting frame 11 is: an inner wall of the first mounting frame 11 defines a guiding area 110, the air vent guiding assembly 12 is mounted in the guiding area 110, and the air vent guiding assembly 12 includes horizontal guiding blades 121 and/or vertical guiding blades 122, such as the horizontal guiding blades 121 and the vertical guiding blades 122 shown in the figures, to flexibly adjust the air output direction of the air vent through the guiding blades arranged in two directions. The first mounting frame 11 is further mounted with a motor 3; the motor 3 is capable of driving the horizontal guiding blades 121 and/or the vertical guiding blades 122 to move to adjust outputting direction of air flow of the second outlet 222.

The motor 3 is able to be mounted at a motor mounting seat 111. As shown in the figures, in some embodiments, an outer wall of the first mounting frame 11 is provided with motor mounting seats 111 on opposite sides in a vertical direction and on opposite sides in a horizontal direction. A plug connector mounting seat for corresponding electrical connection may also be disposed on the first mounting frame 11. As shown in FIGS. 3-9, the outer wall of the first mounting frame 11 further provides a plug connector mounting seat 112 located at adjacent motor mounting seats 111, and adjacent motors 3 installed corresponding to the adjacent motor mounting seats 111 can share the same plug connector mounting seat 112. For clarity of illustrating positions of the motor mounting seat 111 and the plug connector mounting seat 112, the motor 3 and the plug connector 4 are omitted in FIG. 6.

In some embodiments, the shape of the first mounting frame 11 is a substantially square shape as shown in FIGS. 3-9. The first mounting frame 11 is square, the motor mounting seats 111 are arranged in a middle area of each side of the square, and the plug connector mounting seat 112 is arranged at an intersection area of adjacent sides of the square. As shown in FIGS. 6-11, motor mounting seats 111 for mounting the motor 3 are disposed at middle portions of four edges of the square first mounting frame 11, i.e., areas near midpoints of the edges, and the plug connector mounting seat 112 is disposed near corners where two edges intersect. The first module 1 employing the above structure is compact in structure, and the motor and the plug can be flexibly arranged.

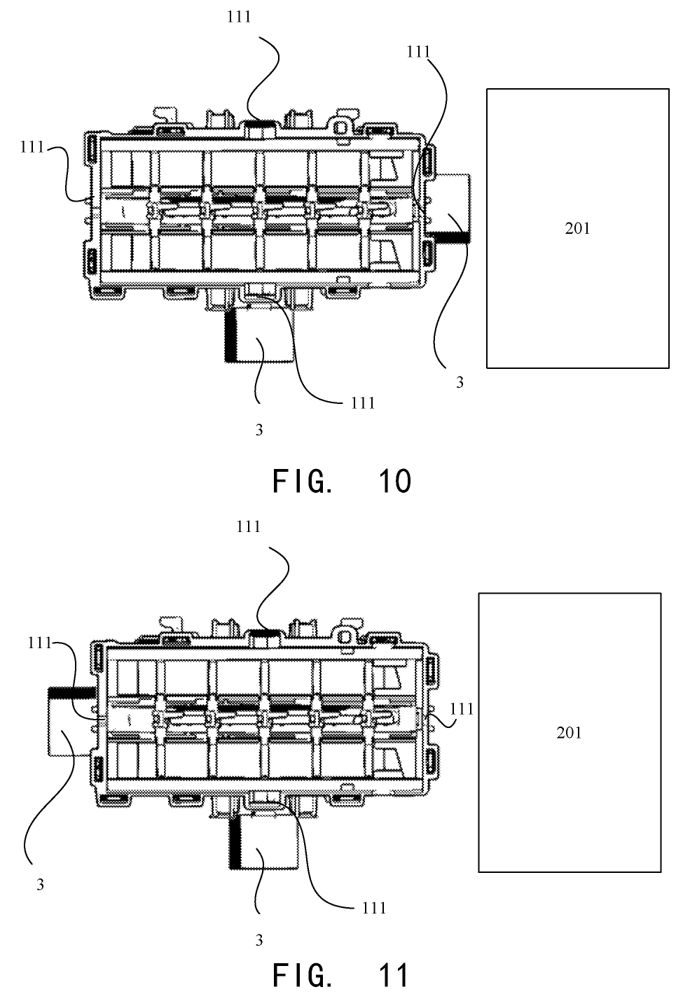

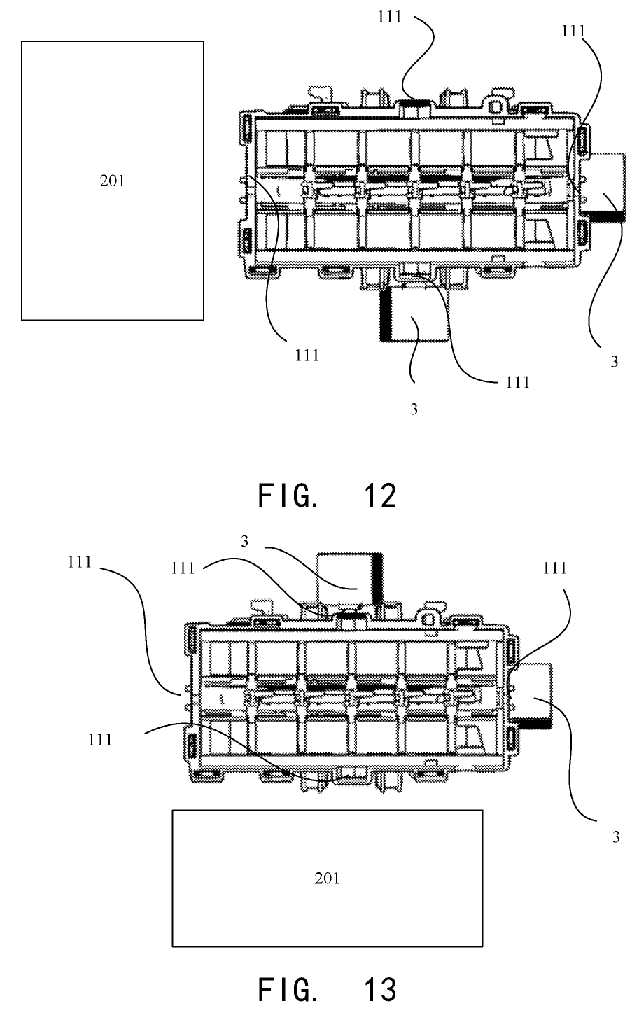

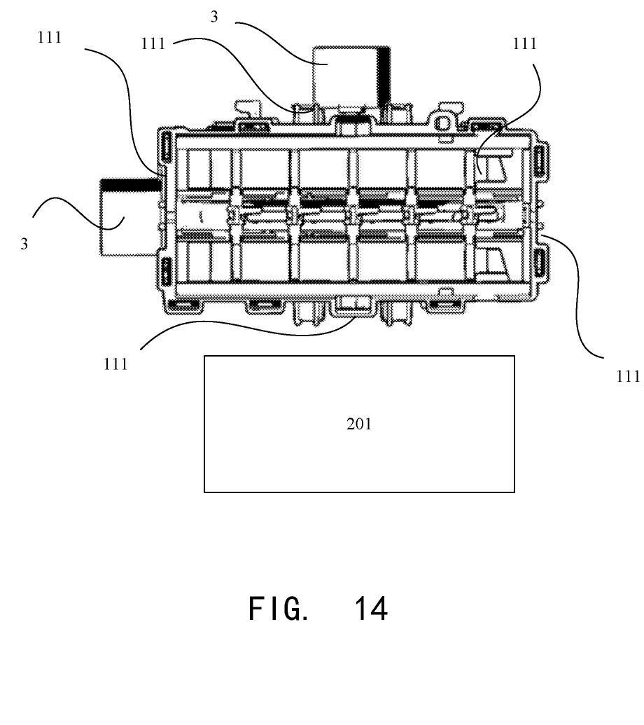

In some embodiments, for example, comparing FIGS. 10 with 11, the panel 200 is provided with a functional part 201, which may be, for example, a center console screen (a screen of more than 10 inches) provided on the instrument panel 1001. The functional part 201 is adjacent to the second outlet 222. Comparing FIG. 10 with FIGS. 11-14, it can be seen that the outer wall of the first mounting frame 11 is provided with motor mounting seats 111 on opposite sides in the vertical direction and on opposite sides in the horizontal direction. The center console screen is located at the right side of the air vent 10. At this time, if one motor 3 is disposed at the motor mounting seat 111 on the right side of the first mounting frame 11 as shown in FIG. 10, space layout will be difficult, and vibration of the motor 3 may affect the use experience of the center console screen. Therefore, the solution of the embodiment is as shown in FIG. 11, that the motor mounting seat 111 closest to the functional part 201 is not provided with the motor 3, that is, the motor 3 is not disposed at the right motor mounting seat 111, and instead the motor 3 is disposed at the left motor mounting seat 111, which is conducive to rationality of the overall spatial layout inside the vehicle. As shown in FIG. 12, when the functional part 201 is located at the left side, the motor arrangement position shown in FIG. 10 is employed. As shown in FIG. 13, when the functional part 201 is located at the lower side, compared with FIG. 12, the motor 3 located at the lower side is disposed at the upper side. As shown in FIG. 14, when the functional part 201 is located at the lower side, compared with FIG. 11, the motor 3 located at the lower side is disposed at the upper side. Such effects are as described above, which is able to prevent vibration of the motor from affecting the use experience of the functional part and facilitate space layout.

In summary, beneficial effects of employing the above embodiments include but are not limited to: by splitting the air vent into a modular design and providing a carry-over module and an updated module, the carry-over module retains the first mounting frame 11 and the air vent guiding assembly 12 mounted thereon, while the second module including the upstream housing with the inlet of the air vent and/or the downstream housing with the outlet serves as the updated module. This saves a great deal of time spent on simulation, testing and other development work for employing the first mounting frame 11 and the air vent guiding assembly 12 in the entire air vent to meet basic functional requirements of air direction adjustment of the air vent. Meanwhile, the updated module can be redesigned and developed according to user demands. This shortens the development cycle of the air vent and reduces development costs. In addition, there is no need to remold the carry-over module, which saves mold costs, especially when the overall mold of the air vent is large. Further, the development cycle of the air system and the vehicle including the air vent is shortened, and manufacturing costs are reduced.

Although the present disclosure is disclosed as above with embodiments, it is not intended to limit the present disclosure. Any person can make possible changes and modifications without departing from the spirit and scope of the present disclosure. Therefore, any modification, equivalent change, and modification made to the above embodiments according to the technical essence of the present disclosure without departing from the content of the embodiments of the present disclosure shall fall within the scope defined by the claims of the present disclosure.

What is claimed is:

1. An air vent, comprising:
a first module, the first module comprising a first mounting frame, the first mounting frame being capable of mounting an air guiding assembly;
a second module, the second module comprising:
an upstream housing and/or a downstream housing, the upstream housing being located upstream to the first module, and the upstream housing having a first inlet and a first outlet;
the downstream housing being located downstream to the first module, and the downstream housing having a second inlet and a second outlet;
an air vent flow path provided by the first module and the second module includes: an airflow enters through the first inlet, passes through the first outlet, the air vent guiding assembly of the first module, the second inlet, and finally the airflow is output to the outside at the second outlet;
wherein, the first module and the second module are separate parts, and the first module is a carry-over module of the air vent, and the second module is an updated module of the air vent.

2. The air vent according to claim 1, wherein an inner wall of the first mounting frame defines a guiding area, and the air vent guiding assembly is mounted inside the guiding area, and the air vent guiding assembly includes a horizontal guiding blade and/or a vertical guiding blade, and the first mounting frame is also mounted with a motor; and the motor is able to drive the horizontal guiding blade and/or the vertical guiding blade to move to adjust outputting direction of airflow of the second outlet.

3. The air vent according to claim 2, wherein an outer wall of the first mounting frame provides a motor mounting seat, and the motor mounting seat is set on the outer wall of the first mounting frame on both sides in the vertical direction and on both sides in the horizontal direction.

4. The air vent according to claim 3, wherein the outer wall of the first mounting frame further provides a plug connector mounting seat, and the plug connector mounting seat is located at adjacent motor mounting seats, and adjacent motors installed corresponding to the adjacent motor mounting seats are able to share the same plug connector mounting seat.

5. The air vent according to claim 4, wherein the first mounting frame is square, the motor mounting seat is arranged in a middle area of each side of the square, and the plug connector mounting seat is arranged at an intersection area of adjacent sides of the square.

6. The air vent according to claim 1, wherein the first module is connected to the upstream housing and/or the downstream housing by a detachable connecting structure; the detachable connecting structure includes a snap-fit connecting structure.

7. The air vent according to claim 1, wherein the first module comprises the first mounting frame, and the second module comprises the upstream housing and the downstream housing; or the first module comprises the first mounting frame and the upstream housing, and the second module comprises the downstream housing; or the first module comprises the first mounting frame and the downstream housing, and the second module comprises the upstream housing.

8. An air system, comprising:
an air vent, comprising a first module, the first module comprising a first mounting frame, the first mounting frame being capable of mounting an air guiding assembly;
a second module, the second module comprising:
an upstream housing and/or a downstream housing, the upstream housing being located upstream to the first module, and the upstream housing having a first inlet and a first outlet;
the downstream housing being located downstream to the first module, and the downstream housing having a second inlet and a second outlet;
an air vent flow path provided by the first module and the second module includes: an airflow enters through the first inlet, passes through the first outlet, the air vent guiding assembly of the first module, the second inlet, and finally the airflow is output to the outside at the second outlet;
wherein, the first module and the second module are separate parts, and the first module is a carry-over module of the air vent, and the second module is an updated module of the air vent;
an air duct; and
a heating, ventilation and air conditioning system;
an upstream end of the air duct is connected to the heating, ventilation and air conditioning system, and a downstream end of the air duct is connected to the first inlet of the air vent.

9. The air system according to claim 8, wherein the air system comprises a plurality of air vents, including a first air vent and a second air vent, the first module of the first air vent is identical in structure to that of the second air vent, and the second module of the first air vent is different in structure from that of the second air vent.

10. The air system according to claim 8, wherein an inner wall of the first mounting frame defines a guiding area, and the air vent guiding assembly is mounted inside the guiding area, and the air vent guiding assembly includes a horizontal guiding blade and/or a vertical guiding blade, and the first mounting frame is also mounted with a motor; and the motor is able to drive the horizontal guiding blade and/or the vertical guiding blade to move so as to adjust outputting direction of air flow of the second outlet.

11. The air system according to claim 10, wherein an outer wall of the first mounting frame provides a motor mounting seat, and the motor mounting seat is set on the outer wall of the first mounting frame on both sides in the vertical direction and on both sides in the horizontal direction.

12. The air system according to claim 11, wherein the outer wall of the first mounting frame further provides a plug connector mounting seat, and the plug connector mounting seat is located at adjacent motor mounting seats, and adjacent motors installed corresponding to the adjacent motor mounting seats are able to share the same plug connector mounting seat.

13. The air system according to claim 12, wherein the first mounting frame is square, the motor mounting seat is arranged in a middle area of each side of the square, and the plug connector mounting seat is arranged at an intersection area of adjacent sides of the square.

14. The air system according to claim 8, wherein the first module is connected to the upstream housing and/or the downstream housing by a detachable connecting structure; the detachable connecting structure includes a snap-fit connecting structure.

15. The air system according to claim 8, wherein the first module comprises the first mounting frame, and the second module comprises the upstream housing and the downstream housing; or the first module comprises the first mounting frame and the upstream housing, and the second module comprises the downstream housing; or the first module comprises the first mounting frame and the downstream housing, and the second module comprises the upstream housing.

16. A vehicle series, each vehicle of the vehicle series comprising an air vent, comprising a first module, the first module comprising a first mounting frame, the first mounting frame being capable of mounting an air guiding assembly;
a second module, the second module comprising:
an upstream housing and/or a downstream housing, the upstream housing being located upstream to the first module, and the upstream housing having a first inlet and a first outlet;
the downstream housing being located downstream to the first module, and the downstream housing having a second inlet and a second outlet;
an air vent flow path provided by the first module and the second module includes: an airflow enters through the first inlet, passes through the first outlet, the air vent guiding assembly of the first module, the second inlet, and finally the airflow is output to the outside at the second outlet;
wherein, the first module and the second module are separate parts, and the first module is a carry-over module of the air vent, and the second module is an updated module of the air vent;
wherein the air vent of each vehicle of the vehicle series has an identical first module, and the second modules of at least two vehicles of the vehicle series are different.

17. The vehicle series according to claim 16, wherein the vehicle further comprises a panel; wherein the second outlet provided by the downstream housing of the air vent is located on a surface of the panel; the panel is provided with a functional part, and the functional part is adjacent to the second outlet; an outer wall of the first mounting frame provides motor mounting seats on both sides in the vertical direction and on both sides in the horizontal direction, and the motor mounting seat closest to the functional part is not provided with a motor.
